(19) United States
(12) Patent Application Publication
(10) Pub. No.: US 2005/0204668 A1
(43) Pub. Date: Sep. 22, 2005

(54) Rot resistant window shutter and method of manufacture therefor

(76) Inventor: Kurt Buchwald, Cumming, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/082,410

(22) Filed: Mar. 17, 2005

Related U.S. Application Data
(60) Provisional application No. 60/554,019, filed on Mar. 17, 2004.

(51) Int. Cl. E06B 7/08

(52) U.S. Cl. 52/473

(57) ABSTRACT

A rot resistant window shutter and method of manufacture therefor, wherein the shutter is manufactured as a one-piece construction from a suitable cellular polyvinyl chloride substrate, and may be selectively structural and/or aesthetically manipulated without concern of degradation of structural integrity of the shutter, and thus without concern of jeopardizing the rot resistivity thereof.

### CROSS-REFERENCE AND PRIORITY CLAIM TO RELATED APPLICATIONS

To the fullest extent permitted by law, the present nonprovisional patent application claims priority to and the full benefit of provisional patent application entitled “Rot Resistant Window Shutter And Method Of Manufacture Therefor”, filed on Mar. 17, 2004, having assigned Ser. No. 60/554,019.

### TECHNICAL FIELD

The present invention relates generally to construction and building components, and more specifically to a rot resistant window shutter and method of manufacture therefor, wherein the present invention advantageously provides a shutter manufactured as a one-piece construction from cellular polyvinyl chloride, as opposed to conventional shutters typically manufactured from multiple pieces of wood or similar rot susceptible substrates.

### BACKGROUND OF THE INVENTION

Conventional wooden window shutters are typically manufactured from multiple pieces of wood, wherein all the wood pieces are glued, nailed, or otherwise fastened, to each other to yield a fully assembled window shutter. Unfortunately, such multi-piece construction wooden shutters must be utilized, as one-piece solid wood boards are much more susceptible to warping over prolonged periods of exposure to the elements of weather, and, in view of the typical dimensions of conventional shutters, must be cut to a size that tends to undesirably express the natural curvature or bow of the wood as derived from the natural columnar-shape of the tree from which the wood was cut. Accordingly, overly curved or warped solid wood boards tend to split or cracked during traditional routering practices utilized to impart aesthetically pleasing designs over the surfaces thereof.

Moreover, the bond provided by the glues or nails often utilized to assemble such multi-piece construction wooden shutters often weakens or otherwise deteriorates, and, as such, results in the dilapidation of the multi-piece shutter, and/or the exposure of untreated, unsealed or unpainted wood pieces to rot-inducing moisture and similar weather elements. Moreover, the natural expansion and contraction of wood material in response to varying weather conditions tends to disrupt the structural integrity of glues between bonded wood pieces, or, if the wood pieces are secured together via nails, such expansion and contraction can disrupt the efficacy of the nail bond, creating gaps between the wood pieces that expose the nail to moisture, and thus cause rusting and structural degradation of the nail, in addition to rotting of exposed and untreated, unsealed or unpainted wood surfaces.

Additionally, wooden shutters in general require regular application of suitable exterior paints or sealers to protect the wood from rot, harsh weather elements, and/or insect infestation (i.e., termites, or the like), and to maintain an aesthetically pleasing appearance. Such regular practice, however, can prove largely burdensome, inconvenient, and expensive. As such, many homeowners, or the like, tend to forgo such regular upkeep, and thus, are soon faced with the burden and expense of replacing severely rotted or damaged wooden shutters.

Therefore, it is readily apparent that there is a need for a rot resistant window shutter of one-piece construction, wherein the shutter is manufactured from cellular polyvinyl chloride, and may be selectively manufactured to any desired dimension without concern of undesirable warping or bending, and thus splitting or cracking of same during application of router equipment thereto and/or other machinery utilized to impart the shutter with a desired structural and/or aesthetic quality. There is a further need for such a rot resistant window shutter that eliminates regular application of suitable exterior paints or sealers thereto.

### BRIEF SUMMARY OF THE INVENTION

Briefly described, in a preferred embodiment, the present invention overcomes the above-mentioned disadvantages and meets the recognized need for such a device by providing a rot resistant window shutter and method of manufacture therefor, wherein the shutter is manufactured as a one-piece construction from a suitable cellular polyvinyl chloride substrate, and may be selectively structural and/or aesthetically manipulated without concern of degradation of structural integrity of the shutter, and thus without concern of jeopardizing the rot resistivity thereof.

According to its major aspects and broadly stated, the present invention in its preferred form is a rot resistant window shutter and method of manufacture therefor, comprising, in general, a solid piece of cellular polyvinyl chloride (PVC) routered to impart a desired pattern that mimics the exterior aesthetics of conventional wood shutters.

More specifically, the present invention is a rot resistant window shutter and method of manufacture therefor, wherein the shutter is preferably manufactured from a solid extruded piece of cellular polyvinyl chloride (PVC), such as, for exemplary purposes only, rigid (solid) cellular PVC, cellular foam PVC, and/or co-extrusions thereof, and wherein the shutter may be manufactured or extruded to any selected dimension without concern of warping, bending or bowing of same. Preferably, guided routers oriented at selected intervals and/or angles are utilized to create a selected pattern over the forward surface of the shutter, wherein such patterns may include, without limitation, raised panels, louvers, geometric shapes, and/or grooves that emulate or impart the shutter with the appearance of a multi-piece construction, and thus mimic the exterior aesthetics of conventional wood shutters. Preferably, the cellular PVC may be extruded with color dyes to impart the shutter with any selected color.

Accordingly, a feature and advantage of the present invention is its ability to provide a rot resistant window shutter and method of manufacture therefor.

Another feature and advantage of the present invention is its ability to provide a shutter manufactured as a one-piece construction from cellular polyvinyl chloride, as opposed to conventional shutters typically manufactured from multiple pieces of wood or similar rot susceptible substrates.

Still another feature and advantage of the present invention is its ability to provide a rot resistant window shutter routered to impart a desired pattern that mimics the exterior aesthetics of conventional wood shutters.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a front view of a rot resistant window shutter according to a preferred embodiment of the present invention;

FIG. 2 is a front view of a rot resistant window shutter according to a preferred embodiment of the present invention;

FIG. 3 is a side view of a rot resistant window shutter according to a preferred embodiment of the present invention;

FIG. 4 is a perspective view of a shutter manufacturing system according to a preferred embodiment of the present invention;

FIG. 5 is a perspective view of a shutter manufacturing system according to a preferred embodiment of the present invention;

FIG. 6 is a perspective view of a shutter manufacturing system according to a preferred embodiment of the present invention;

FIG. 7 is a perspective view of a shutter manufacturing system according to a preferred embodiment of the present invention;

FIG. 8 is a perspective view of a shutter manufacturing system according to a preferred embodiment of the present invention;

FIG. 9 is a perspective view of a shutter manufacturing system according to a preferred embodiment of the present invention;

FIG. 10 is a perspective view of a shutter manufacturing system according to a preferred embodiment of the present invention;

FIG. 11 is a perspective view of a shutter manufacturing system according to a preferred embodiment of the present invention;

FIG. 12 is a perspective view of a shutter manufacturing system according to a preferred embodiment of the present invention;

FIG. 13 is a perspective view of a shutter manufacturing system according to a preferred embodiment of the present invention;

FIG. 14 is a perspective view of a shutter manufacturing system according to a preferred embodiment of the present invention; and, FIG. 15 is a perspective view of a shutter manufacturing system according to a preferred embodiment of the present invention.

### DETAILED DESCRIPTION OF THE PREFERRED AND SELECTED ALTERNATIVE EMBODIMENTS

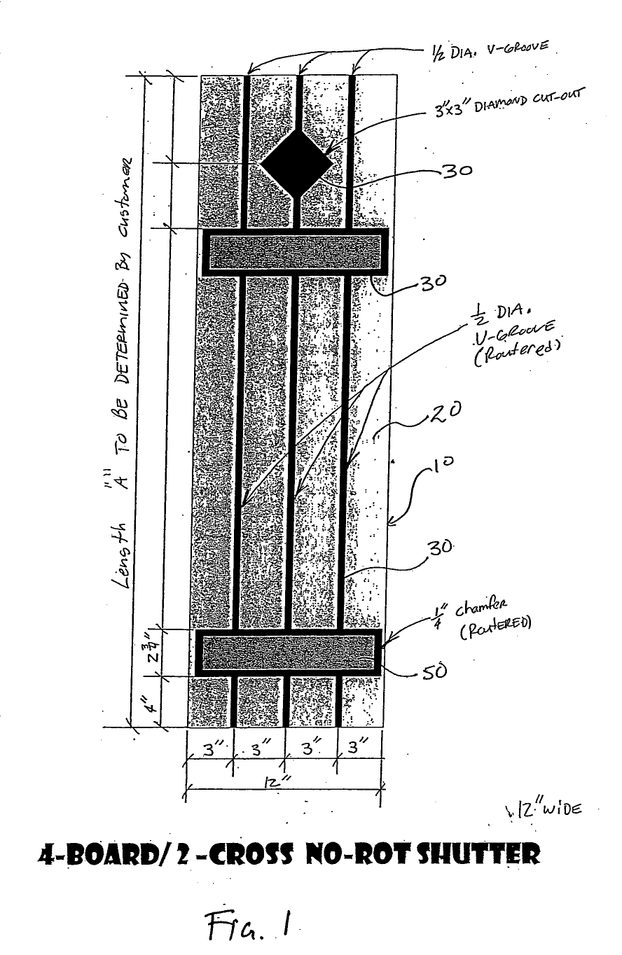

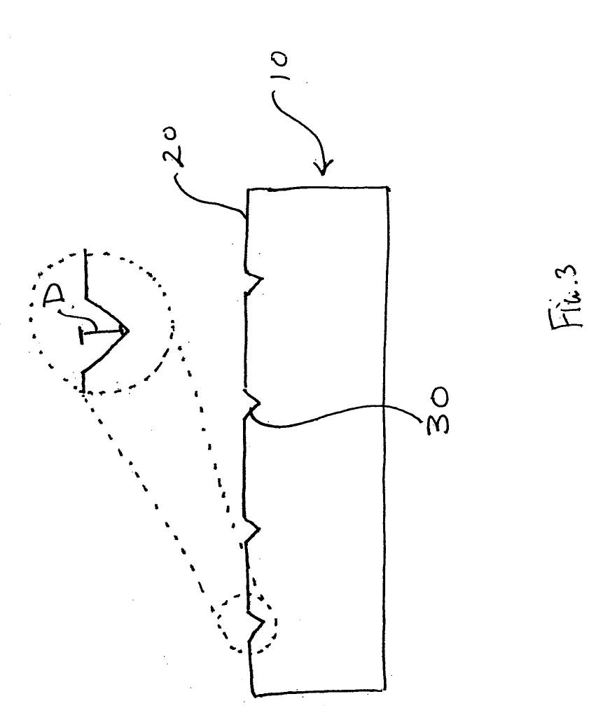

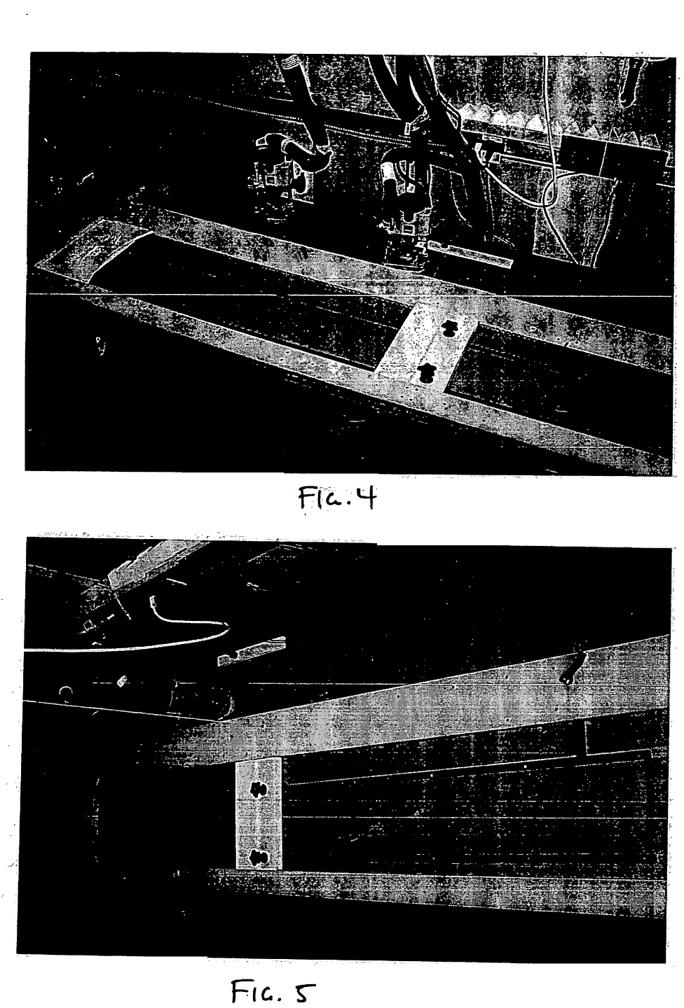

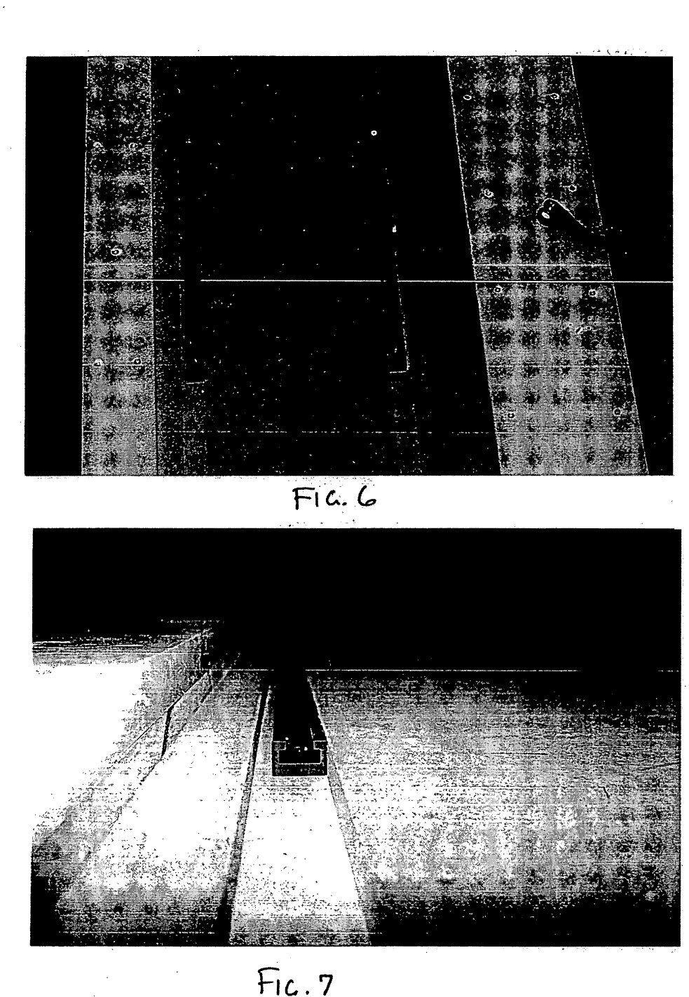

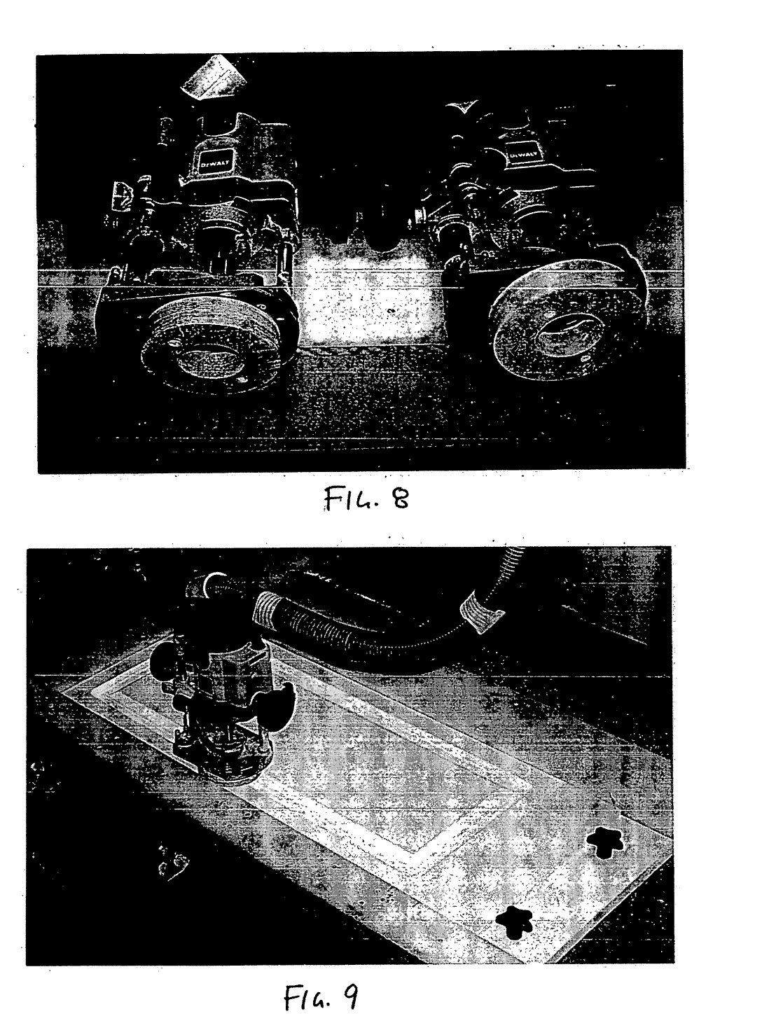

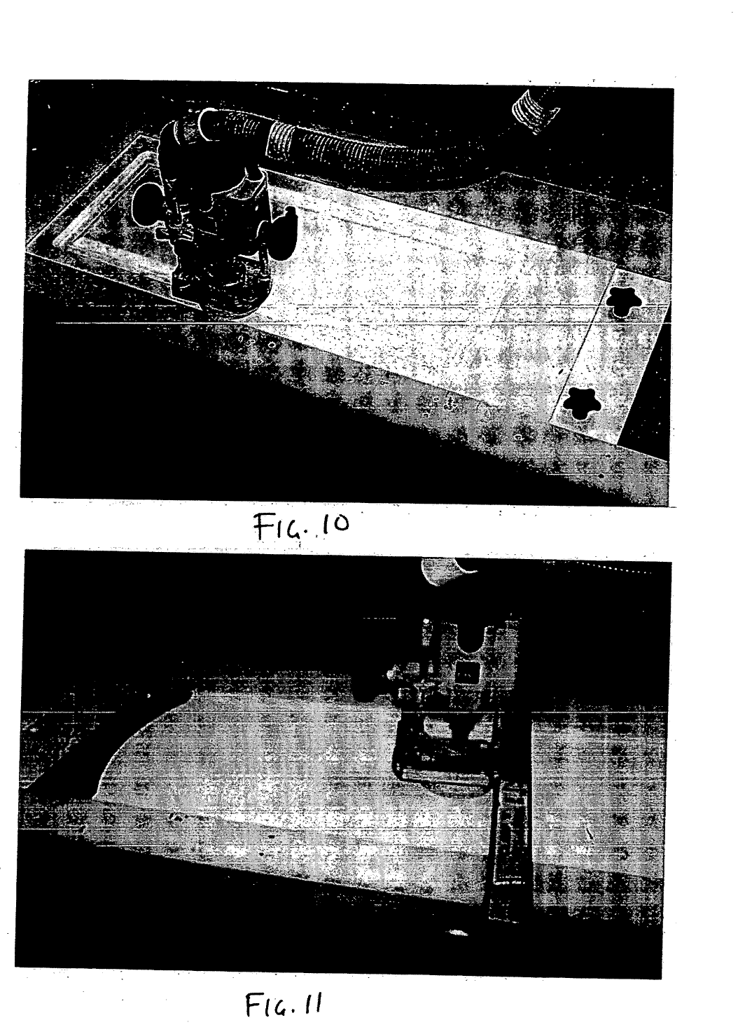

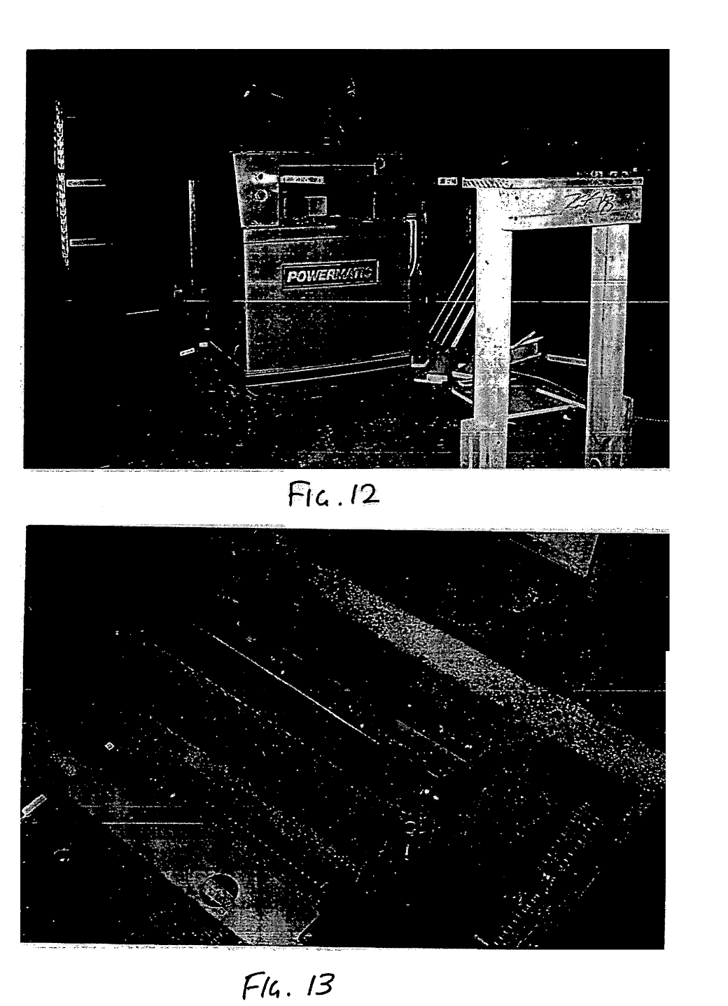

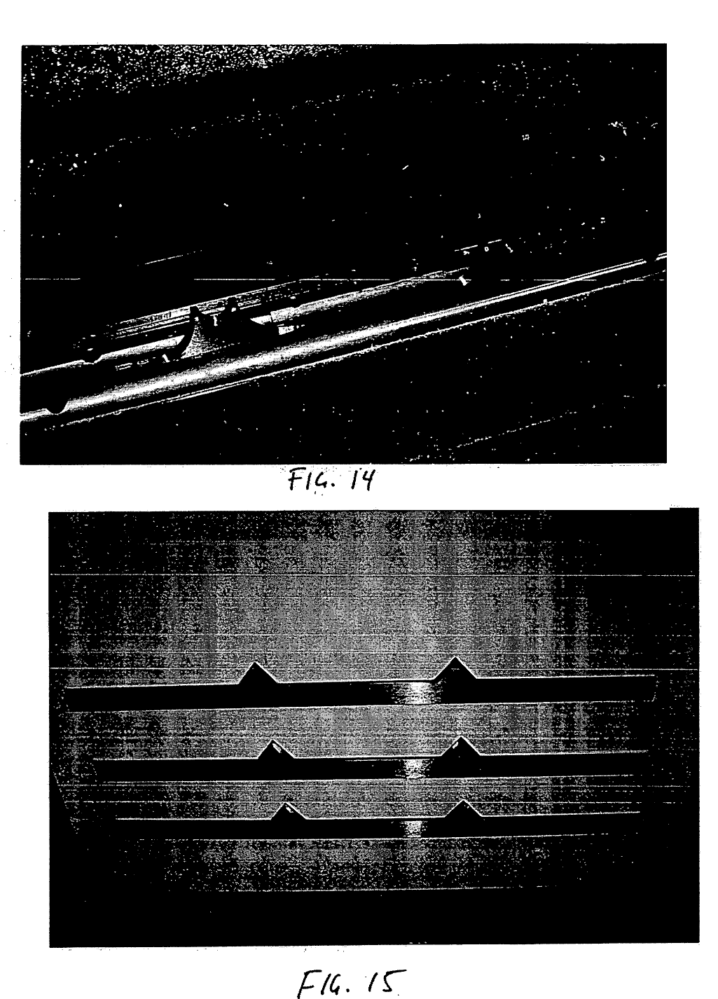

In describing the preferred and selected alternate embodiments of the present invention, as illustrated in FIGS. 1-15, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-15, the present invention in a preferred embodiment is a rot resistant window shutter 10 and method of manufacture therefor. Shutter 10 is preferably manufactured from a solid extruded piece of cellular polyvinyl chloride (PVC), such as, for exemplary purposes only, rigid (solid) cellular PVC, cellular foam PVC, and/or co-extrusions thereof, and may be manufactured or extruded to any selected dimension without concern of warping, bending or bowing of same. Additionally, the cellular PVC substrate utilized to manufacture shutter 10 may be extruded with color dyes blended therewith to impart shutter 10 with any selected color, thus avoiding subsequent application of exterior paints and/or sealers for upkeep of shutter color and/or rot-resistivety.

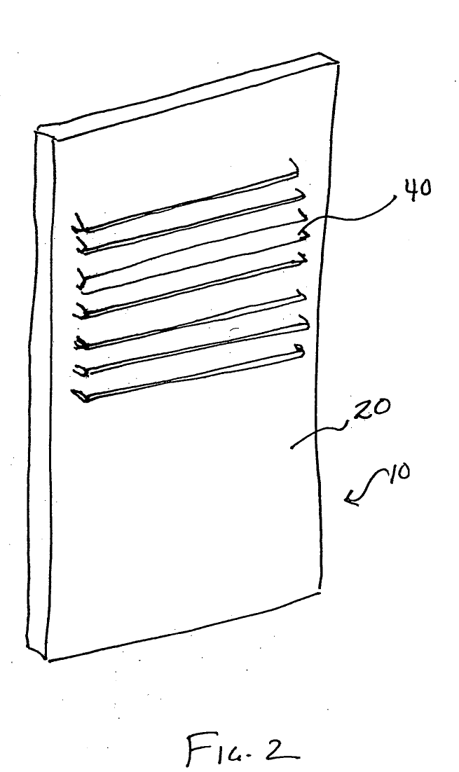

Preferably, the method of manufacture of shutter 10 further utilizes guided routers oriented at selected intervals and/or angles to create a selected pattern 30 over forward surface 20 of shutter 10, wherein patterns 30 may include, without limitation, raised panels, louvers, geometric shapes, and/or grooves that emulate or impart shutter 10 with the appearance of a multi-piece construction, and thus mimic the exterior aesthetics of conventional wood shutters. As best illustrated in FIG. 2, to impart shutter 10 with a louvered appearance, routers are preferably oriented at a selected angle relative to forward surface 20 of shutter 10 (i.e., forty-five degree angle, or any other selected angle), whereupon several passes with the routers over forward surface 20, at selected and equally-spaced intervals, preferably yields a plurality of deep, angled grooves that approximately mimic a plurality of louvers 40 over forward surface 20 of shutter 10.

As best illustrated in FIG. 3, routered pattern 30 and/or routered grooves of louvers 40 preferably extends into forward surface 20 of shutter 10 with sufficient depth D to impart shutter 10 with the appearance of a multi-piece construction.

It is contemplated that shutter 10 may be extruded, routered, chamfered, embossed, cut, CNC routered, or otherwise structurally manipulated to include cross boards 50 integrally formed therewith. Alternatively, such cross boards may be selectively formed from additional pieces of cellular PVC and adhered to forward surface 20 of shutter 10 with suitable PVC glues or other bonding agents resistant to rot and/or degradation.

Preferably, the completed shutter 10 may be securely affixed to a selected building structure via screws, nails, brackets, bonding agents, or the like, without disrupting the rot resistivity of shutter 10.

It should be recognized that shutters 10 may be cut from a larger stock sheets, planks or boards of cellular PVC pre-routered or pre-pattered via embossing, CNC routering, or the like, thereby enabling construction workers to cut a selected quantity of shutters 10 therefrom.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A rot resistant shutter, comprising;
a solid one-piece construction formed from a material selected from the group consisting of cellular polyvinyl chloride, rigid cellular polyvinyl chloride, cellular foam polyvinyl chloride, and combinations thereof; and,
a pattern formed over said one-piece construction, said pattern selected from the group consisting of raised panels, louvers, geometric shapes, grooves that impart said shutter with the appearance of a multi-piece construction, and combinations thereof.

2. The rot resistant shutter of claim 1, wherein said pattern is formed over or through said one-piece construction via CNC routering.

3. The rot resistant shutter of claim 1, comprising a color die blended with said material.

4. A method for manufacturing rot resistant shutter, said method comprising the steps of:
a. obtaining a solid one-piece construction formed from a material selected from the group consisting of cellular polyvinyl chloride, rigid cellular polyvinyl chloride, cellular foam polyvinyl chloride, and combinations thereof; and,
b. imparting a pattern over a forward surface of said one-piece construction, said pattern selected from the group consisting of raised panels, louvers, geometric shapes, grooves that impart said shutter with the appearance of a multi-piece construction, and combinations thereof.

5. The method of claim 4, wherein said step of imparting a pattern comprises routering said pattern into said forward surface.

6. The method of claim 4, wherein said step of imparting a pattern comprises chamfering said pattern into said forward surface.

7. The method of claim 4, wherein said step of imparting a pattern comprises cutting said pattern into said forward surface.

8. The method of claim 4, wherein said step of imparting a pattern comprises embossing said pattern into said forward surface.

9. The method of claim 4, wherein said step of imparting a pattern comprises CNC routering said pattern into said forward surface.

10. A method for manufacturing a rot resistant louvered shutter, said method comprising the steps of:
a. obtaining a solid one-piece construction formed from a material selected from the group consisting of cellular polyvinyl chloride, rigid cellular polyvinyl chloride, cellular foam polyvinyl chloride, and combinations thereof; and,
b. orientating at least one router bit at a selected angle relative to a forward surface of said one-piece construction; and,
c. passing the at least one router bit a plurality of times over said forward surface at selected intervals to yield a plurality of angled grooves that approximately mimic a plurality of louvers.

11. The method of claim 10, further comprising the step of manufacturing shutter stock from which a plurality of shutters may be cut, said step comprising obtaining a sheet of said solid one-piece construction formed from a material selected from the group consisting of cellular polyvinyl chloride, rigid cellular polyvinyl chloride, cellular foam polyvinyl chloride, and combinations thereof.

12. The method of claim 11, further comprising the step of imparting a pattern over a forward surface of said sheet, said pattern selected from the group consisting of raised panels, louvers, geometric shapes, grooves that impart said shutter with the appearance of a multi-piece construction, and combinations thereof.

13. The method of claim 12, further comprising the step of cutting a selected quantity of shutters from said sheet.
